(19) United States
(12) Patent Application Publication
(10) Pub. No.: US 2014/0146575 A1
(43) Pub. Date: May 29, 2014

(54) Switching Converters Using Bipolar Darlington as Power Switching Device

(71) Applicant: Mosway Semiconductor Limited, Hong Kong (HK)

(72) Inventors: Chiu-Sing Celement Tse, Yuen Long (HK); On-Bon Peter Chan, Shatin (HK)

(73) Assignee: Mosway Semiconductor Limited, Hong Kong (HK)

(21) Appl. No.: 14/056,222

(22) Filed: Oct. 17, 2013

(30) Foreign Application Priority Data
Nov. 27, 2012 (CN) 201210491492.X

(51) Int. Cl. H02M 3/335

(52) U.S. Cl. CPC H02M 3/335
USPC 363/20

(57) ABSTRACT

A switching converter circuit includes bipolar devices in a Darlington configuration as a main switching element. Current drive is provided to the first base terminal to turn on the Darlington bipolar device. Base relaxation circuits to both the first and inner base terminals turn off the Darlington bipolar device.

### BACKGROUND OF THE INVENTION

The present invention relates to switching converters. The invention more particularly, although not exclusively, relates to switching converters exploiting bipolar transistors in a Darlington configuration.

### PRIOR ART

Prior art switching converter circuits are illustrated in FIGS. 1 and 2. The major difference between FIG. 1 and FIG. 2 is in the selection of the main switching element. In FIG. 1, the main switching component is a bipolar transistor (117) while in FIG. 2 the main switching element is a MOSFET (217).

Bipolar transistors are much less costly than MOSFETs. However, MOSFETs are preferred, especially at higher power levels. This is due to the following reasons:
(a) Bipolar transistors require continuous base current to keep them in the turn on state while MOSFETs only require the charge up of gate capacitance to turn them on.
(b) The current gain for power bipolar transistors with high breakdown voltage (say, 600-700V) is usually not high (say, at around 10 to 25, or even in some cases less than 10). This renders the power for driving the base substantial, especially when the power converter delivers high power to its output. The efficiency of the switching converter circuit will then be degraded.

By using bipolar transistors in a Darlington configuration, effective current gain is the product of individual transistor current gain. Hence, effective current gain of a few hundred can be obtained easily and the power loss due to base driving can be reduced to comparable with the gate driving for a MOSFET counterpart at the same power level. However, commercially available Darlington transistors are normally in a 3 pin package in which B is the first base and E is the last emitter as shown in FIG. 4. It is easy to turn on by a small base current but the turn-off is very slow due to base relaxation at the inner base (base pin for transistor 402 or 404 in FIG. 4). Therefore, it is not suitable for switching converter applications as slow switching transition from the on state to the off state generates a substantial amount of heat at the switching device. This produces a heat dissipation problem as well as degradation of efficiency.

Another typical switching conversion circuit for non-isolated LED lighting applications is shown in FIG. 3.

The power switching device is again a MOSFET (315) instead of a bipolar transistor.

### OBJECTS OF THE INVENTION

It is an object of the present invention to overcome or substantially ameliorate the above disadvantages and/or more generally to provide an improved switching converter.

### Disclosure of the Invention

There is disclosed herein a switching converter circuit including:
a Darlington bipolar device as a main switching device, the Darlington bipolar device having four terminals, namely a collector, emitter, first base and inner base; and
a switching control circuit to provide current drive to the first base while maintaining the inner base control pin at high impedance during turn-on of the Darlington bipolar device; and
a switching control circuit providing base relaxation for both the first and the inner base terminal of the Darlington switching device during switch-off of the Darlington switching device.

Preferably, the Darlington bipolar device comprises discrete bipolar transistors.

Alternatively, the Darlington bipolar device can comprise two bipolar transistors in a single four-pin package.

Preferably, the Darlington bipolar device comprises two bipolar transistors on a common substrate of a monolithic device.

There is further disclosed herein a switching controller IC for controlling an external Darlington transistor having two corresponding base terminals formed by two bipolar transistors, the switching controller IC including:
two control pins for controlling the two corresponding base terminals of the external Darlington transistor, the first control pin providing current drive to the first base of the Darlington transistor to turn ON the Darlington transistor, and providing a base relaxation path for the first base terminal of the Darlington transistor to turn it OFF, the second control pin providing a high impedance state during turn-on of the Darlington transistor, and providing a base relaxation path for the inner base terminal of the Darlington transistor to turn it OFF.

There is further disclosed herein a switching controller IC integrating a switching control circuit and a first transistor of a Darlington pair with the following pins for interfacing with an external bipolar transistor to form the Darlington pair:
a base connected pin being the emitter of the first bipolar transistor of the Darlington pair in the IC to provide base current to turn on the external bipolar transistor, and also having base relaxation function for turning OFF the external bipolar transistor; and a collector pin which is the collector of the first bipolar transistor in the IC of the Darlington transistor pair to be connected to the collector of the external bipolar transistor.

There is further disclosed herein a switching converter circuit including:
a Darlington bipolar device as a main switching element, the Darlington bipolar device having first and inner base terminals; and
means for providing current drive to the first base terminal to turn on the Darlington bipolar device;
base relaxation circuits to both the first and inner base terminals to turn off the Darlington bipolar device.

The Darlington bipolar device can comprise discrete bipolar transistors.

Alternatively, the Darlington bipolar device can comprise two bipolar transistors on a common substrate of a monolithic device.

The Darlington devices might be provided in a single four-pin package for example.

The first bipolar transistor of the Darlington bipolar device can be packaged together with the switching control circuit as a single integrated circuit (IC). The pin for the emitter and inner base relaxation circuit of the IC connects to the base of an external bipolar transistor and the collector pin of the IC connects to the collector of the external bipolar transistor to form effectively the Darlington transistor as the power switching device with the invented control circuit.

In the preferred circuit architecture, the inner base of the Darlington bipolar transistor configuration is made directly accessible, as well as connected to the active device to improve the turn-off time.

### BRIEF DESCRIPTION OF THE DRAWINGS

FIG. 1 depicts a prior art isolated switching conversion application using a bipolar transistor as a power switching device;

FIG. 2 depicts a prior art isolated switching conversion application using a MOSFET as a power switching device;

FIG. 3 depicts a prior art non-isolated switching conversion application for LED lighting using a MOSFET as a power switching device;

FIG. 4 shows schematically two typical 3 pin Darlington bipolar transistors in more detail;

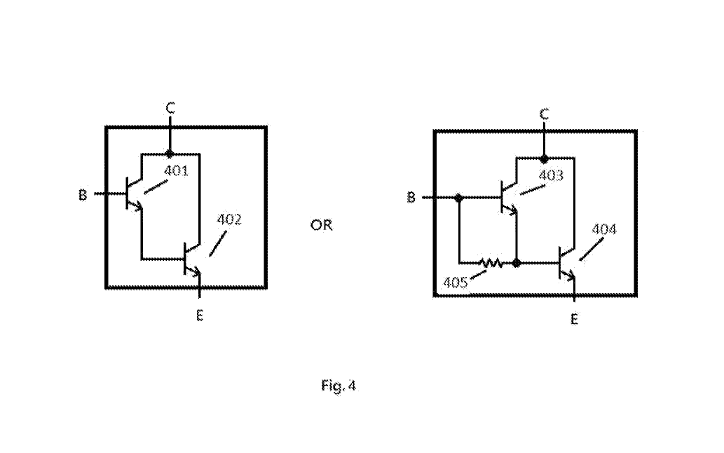

FIG. 5 depicts schematically an isolated switching conversion application using discrete components with an embodiment of the present invention;

FIG. 6 is another schematic depiction of an isolated switching conversion application using a switching controller IC with an embodiment of the present invention;

FIG. 7 is a schematic depiction of a non-isolated switching conversion application for LED lighting embodying the present invention; and

FIG. 8 shows schematically the integration of the switching control circuits together with the first bipolar transistor of the Darlington bipolar transistor as a single integrated circuit (IC).

### DESCRIPTION OF THE PREFERRED EMBODIMENT

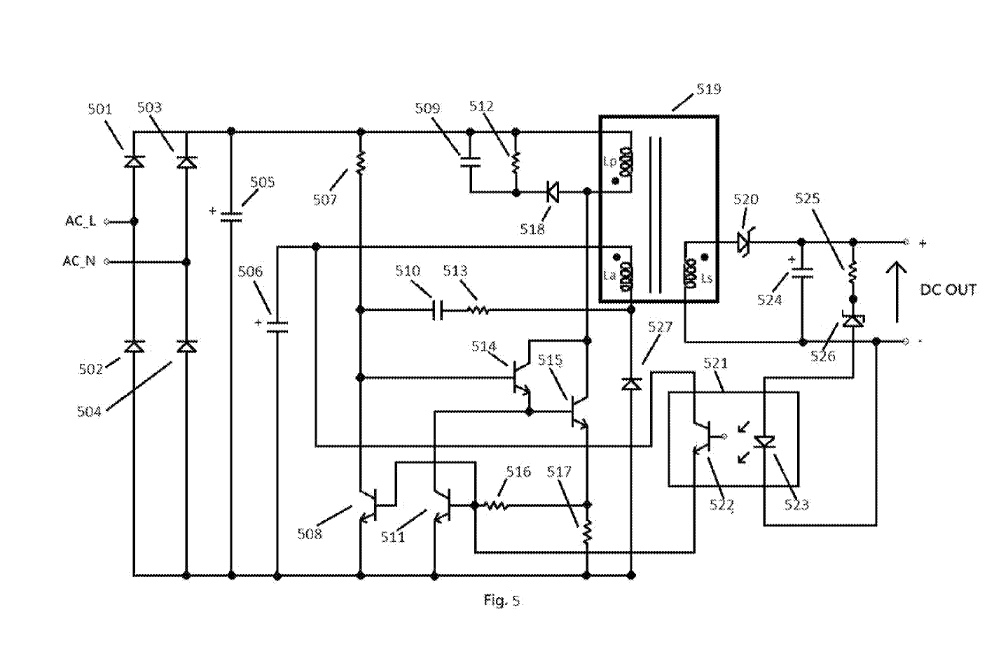

In FIG. 5, diodes 501, 502, 503 and 504 form the diode bridge to rectify the AC input to high voltage DC. Capacitor 505 serves as the filter capacitor for the high voltage DC. Resistor 507 is the start-up resistor that provides the initial current to start the operation upon power up. The start-up current enters the base of bipolar transistor 514. Bipolar transistors 514 and 515 form the Darlington transistor switching device. This base current generates the collector current flowing via the winding LP of the transformer 519, and hence also the current via the winding LA of transformer 519, via resistor 513 and capacitor 510, to further enhance the base current to transistor 514. Collector current will then keep increasing, and hence the emitter current (that approximates the collector current) increases. This will produce an increasing voltage at resistor 517. When the voltage across resistor 517 is sufficiently high to turn on both bipolar transistors 508 and 511, transistor 508 removes base charge from transistor 514 (first transistor of the Darlington pair) while transistor 511 removes base charge from transistor 515 (the inner transistor of the Darlington pair). This will turn off the Darlington transistor with a fast response time. Transformer 519 will then release energy stored to both the secondary windings LS and LA. At the secondary side, diode 520 serves as the rectifying diode while capacitor 524 serves as the filter capacitor. At the primary side, diode 527 serves as the rectifying diode while capacitor 506 serves as the filter capacitor for the LA winding. In addition, diode 518, resistor 512, and the high voltage capacitor 509 together form a snubber circuit for the primary winding LP. Upon completion of energy transfer from LP to LS and LA, the voltage across LP, LS and LA returns to zero. Hence, the node between LA and diode 527 will jump from approximately −0.7V to the voltage across capacitor 506. This will then start current into the base of transistor 514 again via capacitor 514 and resistor 515. Such energy transfer cycles will continue until the secondary side DC OUT reaches the desired voltage defined by the Zener voltage of diode 526 plus the forward voltage of the light emitting diode (LED) 523 in the optical coupler 521. Resistor 525 serves as the current limiting resistor. When the DC OUT is above the desired voltage, the LED 523 inside optical coupler 521 is on, which causes the photo-transistor 522 inside optical coupler 521 to turn on. Subsequently, both transistor 508 and transistor 511 are turned on, while transistor 514 and transistor 515 are turned off. The switching conversion cycles are then disabled. Switching conversion cycle will resume when DC OUT drops below the desired value, which turns off the LED 523 inside optical coupler 521 and turns off the photo-transistor 522 inside optical coupler 521. With the feedback control via optical coupler 521, load regulation is achieved.

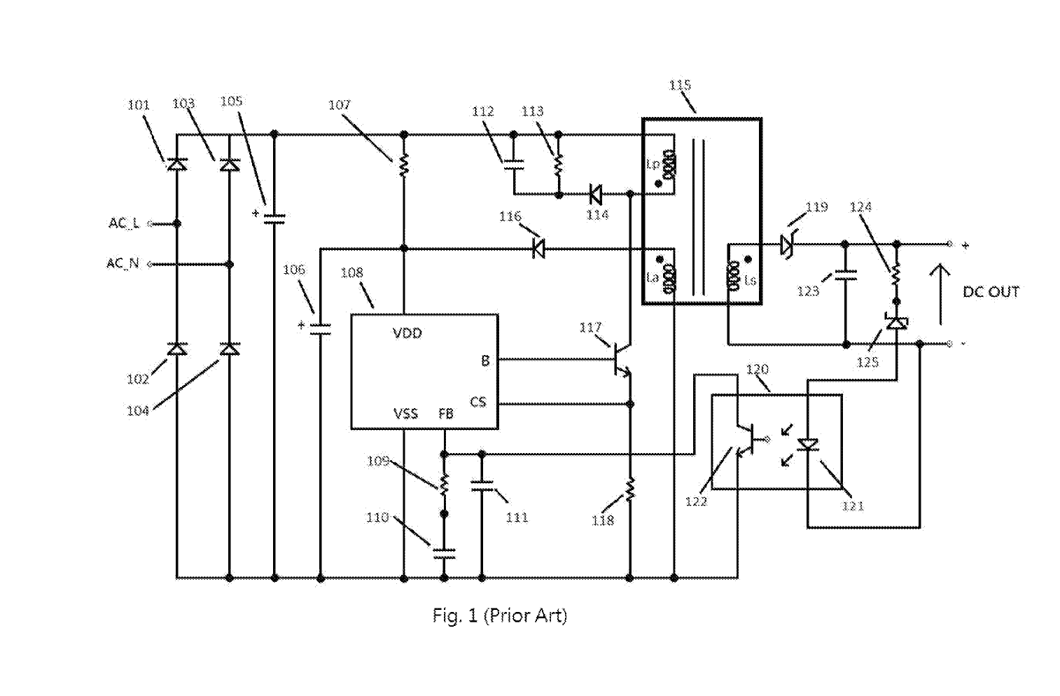

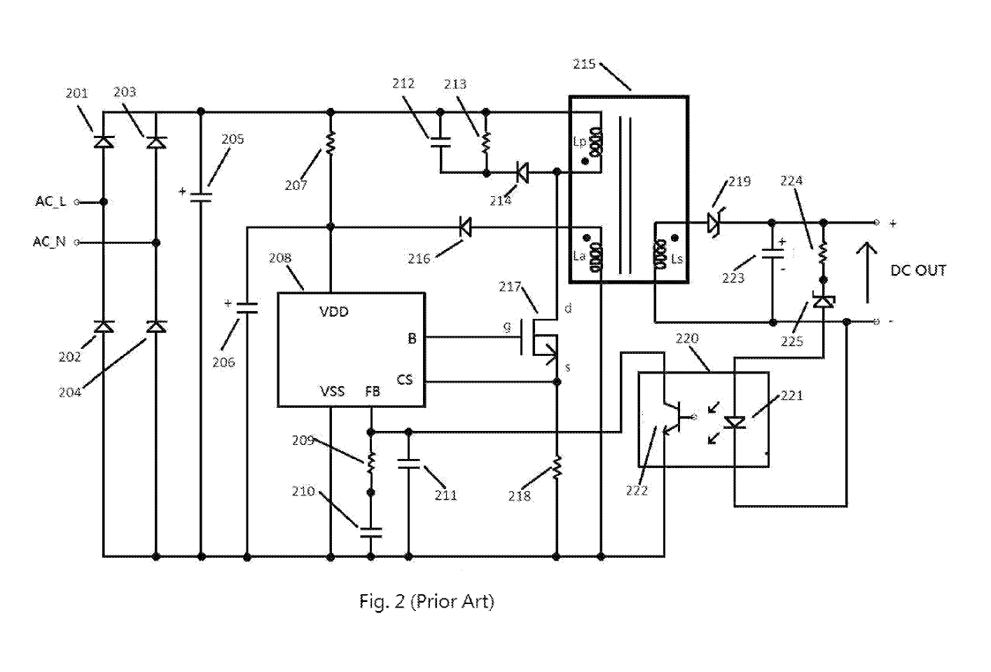

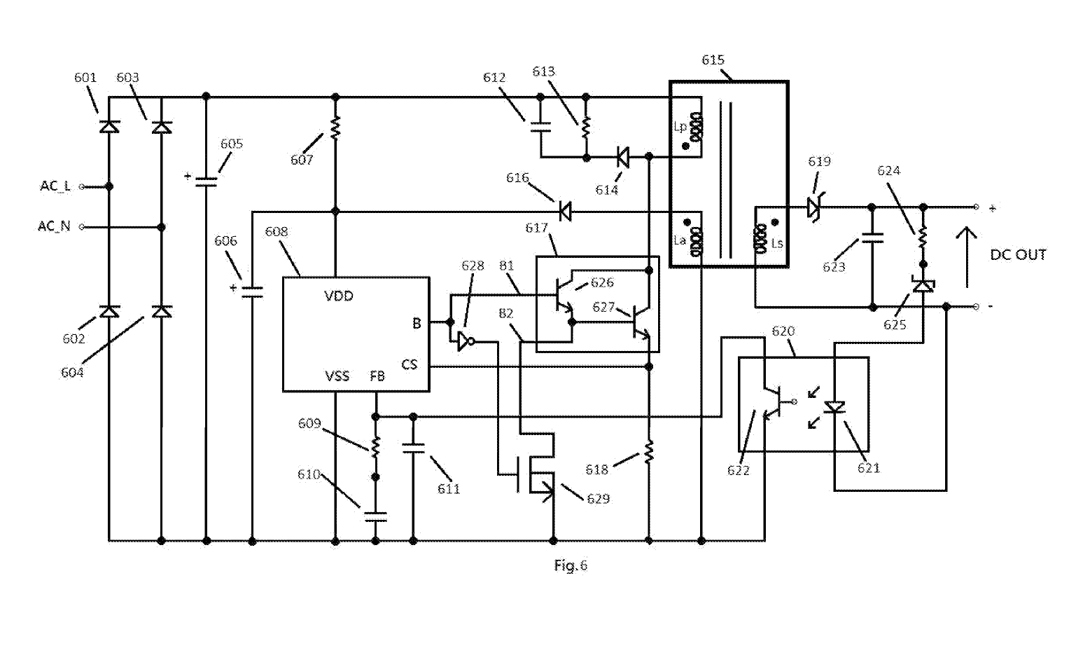

FIG. 6 is another preferred embodiment of the invention. Basically, this replaces the power switching device in FIG. 1 or FIG. 2 (117 and 217 respectively) with Darlington transistor pair 617 and adding a base relaxation circuit 628 and 629 for the base of transistor 627 (B2). To turn OFF the Darlington pair 617, inverter 628 inverts the B1 signal and turns ON MOSFET 629, which provides a low impedance path to discharge the base charge of transistor 627. The switching controller IC 608 and the additional control circuit for base relaxation (628 and 629) are preferably integrated into a single integrated circuit (IC).

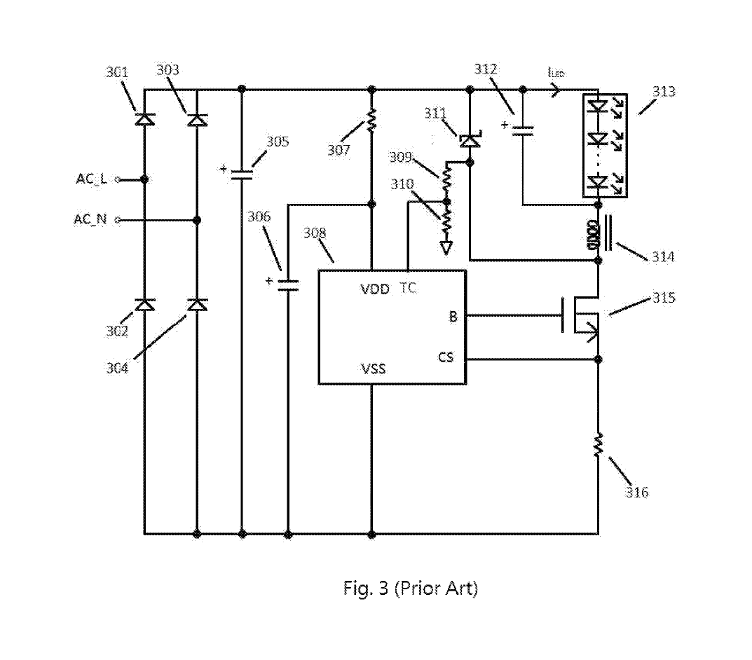

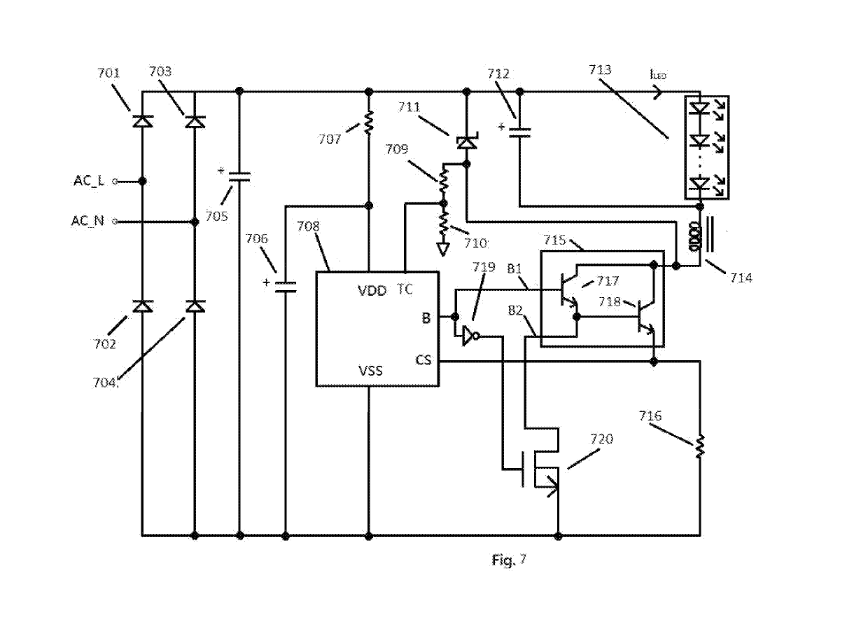

FIG. 7 is another preferred embodiment exploiting the invention in a non-isolated switching converter for LED lighting. This circuit is formed by replacing the MOSFET power switch 315 in FIG. 3 with a Darlington transistor pair 715 formed by bipolar transistors 717 and 718, as well as the addition of the base relaxation circuit for the base of transistor 718 during turn OFF. Inverter 719 inverts the B1 signal to turn on MOSFET 720 during the OFF state to provide a low impedance path for discharging the base charge of transistor 718. Again, the switching controller IC and the additional base relaxation circuit can be integrated into a single integrated circuit (IC).

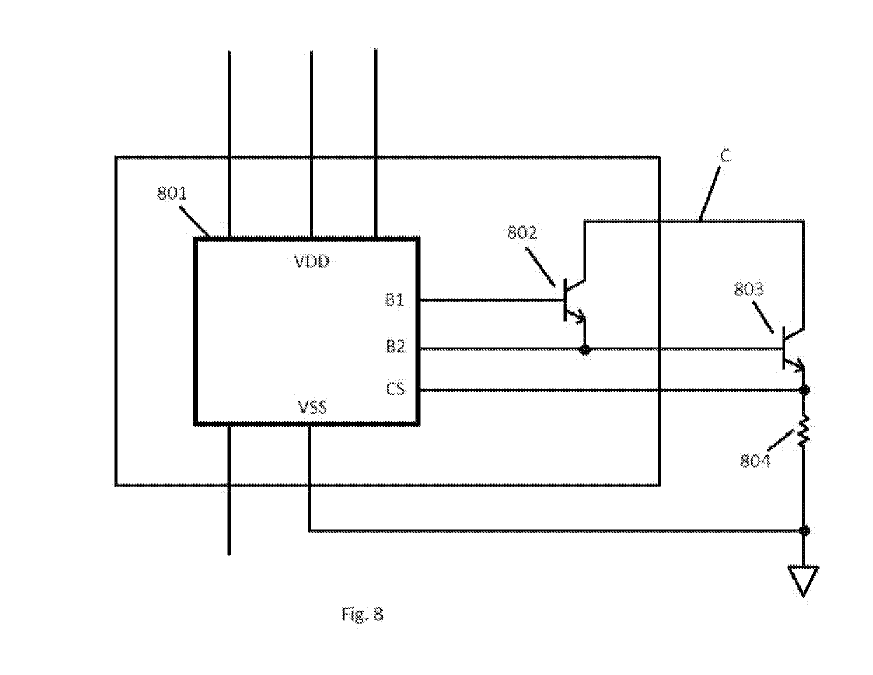

In the Darlington transistor pair, since most of the current and hence heat dissipation, is associated with the second bipolar transistor, it is therefore possible to integrate the first bipolar transistor together with the associated switching controller IC into a single chip since thermal dissipation is not the limiting factor. Furthermore, this provides the user with the flexibility to use standard power bipolar transistor as the second transistor to form effectively the Darlington pair. In FIG. 8, 801 is the switching controller IC while 802 is the first bipolar transistor of the Darlington pair. These can be integrated into a single package.

A Darlington bipolar configuration using two bipolar transistors is illustrated. However, the concept can be extended to using multiple (more than two) bipolar transistors.

1. A switching converter circuit including:
a Darlington bipolar device as a main switching device, the Darlington bipolar device having a collector, an emitter, a first base and an inner base; and
a switching control circuit to provide current drive to the first base while maintaining the inner base control pin at high impedance during turn-on of the Darlington bipolar device; and
a switching control circuit providing base relaxation for both the first and the inner base terminal of the Darlington switching device during switch-off of the Darlington switching device.

2. The switching device of claim 1, wherein the Darlington bipolar device comprises discrete bipolar transistors.

3. The switching device of claim 1, wherein the Darlington bipolar device comprises two bipolar transistors in a single four-pin package.

4. The switching device of claim 1, wherein the Darlington bipolar device comprises two bipolar transistors on a common substrate of a monolithic device.

5. A switching controller IC for controlling an external Darlington transistor having two corresponding base terminals formed by two discrete or monolithic bipolar transistors, the switching controller IC including:
two control pins for controlling the two corresponding base terminals of the external Darlington transistor, the first control pin providing current drive to the first base of the Darlington transistor to turn ON the Darlington transistor, and providing a base relaxation path for the first base terminals of the Darlington transistor to turn it OFF, the second control pin providing a high impedance state during turn-on of the Darlington transistor, and providing a base relaxation path for the inner base terminals of the Darlington transistor to turn it OFF.

6. A switching controller IC integrating a switching control circuit and a first transistor of a Darlington pair with following pins for interfacing with an external bipolar transistor to form the Darlington pair:
a base connected pin being an emitter of the first bipolar transistor of the Darlington pair in the IC to provide base current to turn on the external bipolar transistor, and also having base relaxation function for turning OFF the external bipolar transistor; and
a collector pin which is a the collector of the first bipolar transistor in the IC of the Darlington transistor pair to be connected to the collector of the external bipolar transistor.
